(19) United States
(12) Patent Application Publication
(10) Pub. No.: US 2018/0080133 A1
(43) Pub. Date: Mar. 22, 2018

(54) RECYCLING LITHIUM FROM MIXTURES INCLUDING RADIOACTIVE METAL IONS AND OTHER CONTAMINANTS

(71) Applicant: Bes Technologies, LLC, Oak Ridge, TN (US)

(72) Inventor: William Novis Smith, Philadelphia, PA (US)

(21) Appl. No.: 15/700,747

(22) Filed: Sep. 11, 2017

Related U.S. Application Data
(60) Provisional application No. 62/396,362, filed on Sep. 19, 2016.

(51) Int. Cl. C25C 1/02; B01D 15/36; B01D 15/12; C01D 15/04

(52) U.S. Cl. CPC C25C 1/02; B01D 15/361; C01P 2006/80; C01D 15/04; B01D 15/125

(57) ABSTRACT

A method of purifying aqueous solubilized lithium compounds from other aqueous solubilized or suspended metal salts, including radioactive elemental ions, is described. The method also may purify aqueous solubilized lithium from aqueous solubilized or suspended organic and other contaminants.

### REFERENCE TO RELATED APPLICATIONS

This application claims the benefit of U.S. Provisional Application No. 62/396,362 entitled “Recycling Lithium from Mixtures Including Radioactive Metal Ions and Other Contaminants” filed Sep. 19, 2016, which is incorporated by reference in its entirety.

### BACKGROUND

Lithium metal is used in multiple industries including rechargeable batteries, glass, ceramics, alloys, lubricants, light-weight alloys, pharmaceuticals, and the like. The rechargeable lithium battery is the preferred power source for hybrid and electric vehicles. Furthermore, the market for conventional rechargeable lithium batteries for cell phones, notebook computers, and the like is expected to continually grow.

In addition, lithium is increasingly being applied in the electrical, chemical, and energy fields as well as in hybrid and electric vehicle industries due to a global movement towards more stringent environmental regulations. Thus, domestic and foreign demand for lithium is expected to continue to increase.

Natural lithium, an alkali metal, consists of two isotopes, ⁶Li (“lithium-6”) and ⁷Li (“lithium-7”), with respective abundances of ˜5% and ˜95%, respectively. The lithium-6 isotope has the ability to capture slow-moving neutrons, while the lithium-7 isotope does not. Lithium-6 can be separated from lithium-7 by multiple methods, including the two general categories of chemical and physical separations. Conventional chemical separation methods include lithium-mercury exchange, ion exchange chromatography, extraction, fractional crystallization, fractional precipitation, and the like; while conventional physical separation methods include electromagnetic methods, molten salt electrolysis, electron mobility, molecular distillation, laser separation, and the like. Thus, it is a relatively energy intensive and expensive process to separate the lithium-6 isotope from the more abundant lithium-7 isotope.

To reuse or recycle the more valuable lithium-6 isotope, the lithium-6 isotope must be separated from other impurities and compounds that may be contaminated with radioactive isotopes of other elements, other alkali metals, and heavy metals. Removal of the radioactive elemental isotopes and other undesirable contaminants from the stable lithium-6 isotope allows for recycling and reuse of the valuable lithium-6 isotope. Although to a lesser extent, removal of the radioactive elemental isotopes and other undesirable contaminants from the isotopically-pure lithium-7 isotope or lithium-6, or a blend of the lithium-6 and lithium-7 isotopes, also allows for recycling and reuse of the lithium materials.

There also is a need to purify and recycle the lithium-6 from solutions of lithium compounds obtained by the careful hydrolysis and washing of filters and powders obtained in the processing of isotopically pure lithium-6 hydride, deuteride, and hydroxide mixtures obtained by the careful hydrolysis of these hydride, deuteride, and hydroxide or even lithium metal materials. Due to the very reactive nature of these materials, the hydrolysis may be conducted in a closed metal cabinet or reactor under controlled humidity with nitrogen in the case of the hydrides or deuterides, and with argon in the case of the lithium metal. These solutions are initially basic and the pH is generally adjusted to 4 or below for complete washing and solubilization of the contained lithium-6 isotope compounds from the filters or other supporting or containing substrates.

As can be seen from the above description, there is an ongoing need for simple and efficient methods for recycling and reusing isotopically-pure lithium as lithium compounds, especially lithium compounds contaminated with radioactive isotopes of other elements, other alkali metals, and heavy metals. The materials and methods of the present invention overcome at least one of the disadvantages associated with conventional purification methods.

Other systems, methods, features and advantages of the invention will be, or will become, apparent to one with skill in the art upon examination of the following figures and detailed description. It is intended that all such additional systems, methods, features, and advantages be included within this description, be within the scope of the invention, and be protected by the claims that follow. The scope of the present invention is defined solely by the appended claims and is not affected by the statements within this summary.

### BRIEF DESCRIPTION OF THE FIGURES

The components in the figures are not necessarily to scale and are not intended to accurately represent molecules or their interactions, emphasis instead being placed upon illustrating the principles of the invention. Moreover, in the figures, like referenced numerals designate corresponding parts throughout the different views.

FIG. 1 represents a purification method of forming a purified lithium salt.

### DETAILED DESCRIPTION

A method of purifying aqueous solubilized lithium compounds from other aqueous solubilized or suspended metal salts, including radioactive elemental ions, is described. The method also may purify aqueous solubilized lithium from aqueous solubilized or suspended organic and other contaminants.

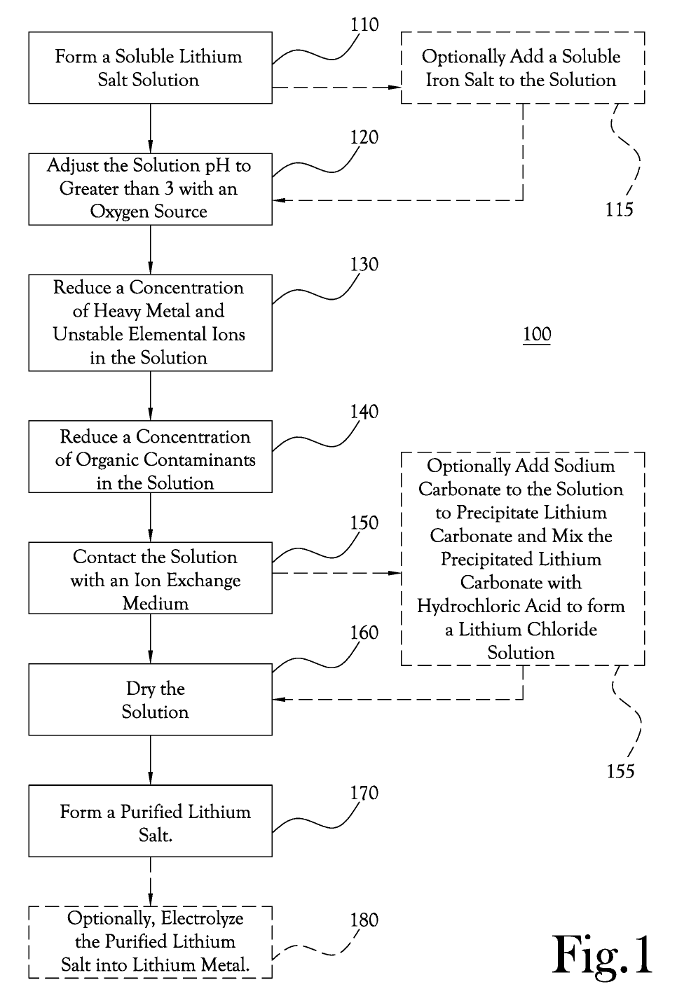

FIG. 1 represents a purification method 100 of forming a purified lithium salt. The method 100 includes forming a soluble lithium salt solution 110, then adjusting the solution pH to greater than three with an oxygen source 120, reducing a concentration of heavy metal ions in the solution 130, reducing a concentration of organic contaminants in the solution 140, contacting the solution with an ion exchange medium 150, drying the solution 160, and optionally forming a purified lithium salt 170. Additionally, before adjusting the solution pH to greater than three, in 115, a soluble iron salt may be added to the solution at a weight percent from 0.1 to 6 weight percent (weight of soluble iron salt/weight of solution). Another variation is presented in 155, where after contacting the solution with the ion exchange medium, sodium carbonate may be added to the solution to precipitate lithium carbonate, which is isolated. Hydrochloric acid is added to the precipitated lithium carbonate until a solution pH of 6 is reached. The solution is dried to form anhydrous lithium chloride having the lithium isotopic purity of the starting impure lithium compound.

In 110, a soluble lithium salt solution is formed. The soluble lithium salt may be formed by combining a feed solution, mixture, suspension, and the like including contaminated lithium compounds with aqueous acid. While many forms of contaminated lithium compounds may be used, contaminated lithium compounds including hydrolyzed lithium hydride, deuterated lithium waste materials, and the like may be used. The contaminated lithium compounds may be in powder, particulate, or other solid form, or may be in solution. The aqueous acid preferably is hydrochloric acid, but other aqueous acids compatible with the purification method may be used. Preferably, the aqueous acid is used to reduce the pH of the soluble lithium salt solution to three and below. The soluble lithium salt solution may have a pH of below 4 to a pH of 8. While not required, preferably this solution is optically clear.

In optional 115, a soluble iron salt may be added to the solution at a weight percent from 0.1 to 6 weight percent (weight of soluble iron salt/weight of solution). The soluble iron salt may be ferrous sulfate, ferric nitrate, ferrous chloride, ferric chloride, and the like. Preferably, the soluble iron salt is added at a weight percent from 0.2 to 3 weight percent

In 120, the solution pH is adjusted to greater than pH three in the presence of an oxygen source. Preferably, the pH is adjusted to 5 to 8. The oxygen source may be gaseous oxygen, air, hydrogen peroxide, persulfate, and the like. When optional 115 is used and the pH is adjusted toward neutral from the lower pH of the soluble lithium salt solution, ferric hydroxide and other oxides precipitate and may co-precipitate with some radioactive ions and other impurities.

In 130, the concentration of heavy metals in the solution is reduced. Such heavy metal concentration reduction may be performed by filtration of the heavy metals from the solution. Such filtration is responsive to the pH adjustment of the solution with the oxygen source in 120.

In 140, the concentration of organic contaminants in the solution is reduced. Such organic contaminant reduction may be performed by contacting the solution with carbon. The carbon may be in the form of activated charcoal, charcoal, carbon surfaced polymeric materials including beads and screens, and the like. As the organic contaminants in the solution are believed to have a greater affinity for the carbon than for the water and other constituents of the solution, the organic contaminants are believed to adsorb on the carbon and thus be removed from the solution. Removal of organic contaminants onto the carbon reduces the concentration of the organic contaminants in the solution. In addition some of the radioactive and the heavy metal ions will also be absorbed in this step.

In 150, the solution is contacted with a strong ion exchange medium. As the radioactive elemental and heavy metal ions in the solution are believed to have a greater affinity for the ion exchange medium than for the water and other constituents of the solution, the radioactive elemental and heavy metal ions are believed to adsorb on the ion exchange medium and thus be removed from the solution. Removal of radioactive elemental and heavy metal ions onto the ion exchange medium reduces the concentration of the radioactive elemental and heavy metal ions in the solution.

In optional 155, sodium carbonate is added to the solution and at least a portion of the formed lithium carbonate is precipitated. The precipitated lithium carbonate after isolation then may be mixed with hydrochloric acid and the solution pH adjusted to 5 to 7, preferably from 5.8 to 7.0, to form a solution of lithium chloride. The precipitated lithium carbonate may be removed from the original solution by multiple mechanical techniques, including filtration, decantation, centrifugation, and the like. The aqueous hydrochloric acid preferably is added to the precipitated lithium carbonate to form a second solution, and not to the original formed solution from which the lithium carbonate was precipitated. Optional 155 is preferably used when a soluble iron salt is added in optional 115, but also may be used in other instances, such as when the soluble lithium salt solution is known to contain additional soluble alkali metal cations, such as sodium and/or potassium.

In 160, the first or second solution is dried. Drying is preferably performed by heating and reduced pressure singularly or in combination. Heating may be provided in many direct and indirect ways, including with ovens, electric coils, infrared, quarts lamps, and the like. Reduced pressure may be provided by placing the solution under vacuum, including with vacuum pumps and the like.

In 170, a purified lithium salt is formed from the drying 160. The salt is preferably a solid and may be in an amorphous, crystalline, semi-crystalline, or other form. The lithium salt is lithium chloride when optional 155 is used.

In optional 180, the purified lithium chloride salt may be electrolyzed to form lithium metal. The resulting metal will have substantially the same ratio of lithium-6 to lithium-7 as present in the soluble lithium salt solution and in the starting contaminated lithium compounds.

While various aspects of the invention are described, it will be apparent to those of ordinary skill in the art that other embodiments and implementations are possible within the scope of the invention. Accordingly, the invention is not to be restricted except in light of the attached claims and their equivalents.

1. A method of forming a purified lithium salt, the method comprising:
forming a soluble lithium salt solution;
adjusting the solution pH to greater than three with an oxygen source;
reducing a concentration of organic contaminants in the solution;
reducing a concentration of heavy metal ions in the solution;
contacting the solution with an ion exchange medium;
drying the solution; and
forming a purified lithium salt.

2. The method of claim 1, where the oxygen source is selected from the group consisting of gaseous or liquid oxygen, air, hydrogen peroxide, persulfate, and combinations thereof.

3. The method of claim 1, where the reducing the concentration of heavy metal ions in the solution includes filtering the solution after the oxidative step.

4. The method of claim 1, where the reducing the concentration of organic contaminants in the solution includes contacting the solution with carbon.

5. The method of claim 1, where the ion exchange medium reduces the concentration of radioactive elemental and heavy metal ions in the solution.

6. The method of claim 1, where the drying the solution includes at least one of heating the solution and placing the solution under reduced pressure.

7. The method of claim 1, further comprising electrolyzing the purified lithium chloride to form lithium metal.

8. The method of claim 1, where the pH is adjusted to 5 to 8.

9. The method of claim 1, where the pH is adjusted to 5.8 to 7.0.

10. The method of claim 1, the method further comprising before adjusting the solution pH adding a soluble iron salt to the solution at a weight percent from 0.1 to 6 (weight of soluble iron salt/weight of solution).

11. The method of claim 10, where the soluble iron salt is selected from the group consisting of ferrous sulfate, ferric nitrate, ferrous chloride, ferric chloride, and combinations thereof.

12. The method of claim 10, further comprising before drying the solution,
contacting the solution with sodium carbonate,
precipitating at least a portion of formed lithium carbonate,
contacting the precipitated lithium carbonate with hydrochloric acid to form a lithium chloride solution.

13. The method of claim 12, further comprising adjusting the lithium chloride solution to a pH of 5 to 7.

14. The method of claim 1, where the forming the soluble lithium salt solution includes combining a feed solution including contaminated lithium compounds with aqueous acid.

15. The method of claim 14, where the contaminated lithium compounds include at least one of hydrolyzed lithium hydride and deuterated lithium waste materials.

16. The method of claim 14, where the contaminated lithium compounds may be in powder or particulate form.

17. The method of claim 14, where the aqueous acid is hydrochloric acid.

18. The method of claim 14, where the soluble lithium salt solution has a pH of below 4 to a pH of 8.
